(19) United States
(12) Patent Application Publication
(10) Pub. No.: US 2007/0161511 A1
(43) Pub. Date: Jul. 12, 2007

(54) Laundry-safe photo blanket and method for making same

(76) Inventor: Jacqueline Wyllie, Oxford, MA (US)

Correspondence Address: O'Connell Mirick;DeMallie & Lougee, LLP, 100 Front Street, Worcester, MA, 01608, US

(21) Appl. No.: 11/329,348

(22) Filed: Jan. 10, 2006

(51) Int. Cl. B41M 5/035

(52) U.S. Cl. 503/227

(57) ABSTRACT

A laundry-safe photo blanket and methods for making the photo blanket of the invention, having a size and shape, that comprises the steps of: providing one or more digital images; printing a sublimation template for the digital image wherein the template has a size and shape and a front side and backside; providing a deformable printing block corresponding to the size and shape of the sublimation template; providing one or more sublimation substrates, comprising a polyester material and corresponding to the size and shape of the photo blanket; placing the deformable printing block on a surface of a heat press; placing the sublimation substrate on the printing block; placing the sublimation template front side down on the sublimation substrate; and applying the sublimation template to the sublimation substrate by compressing the substrate and template together in the heat press.

### FIELD OF THE INVENTION

This invention relates to blankets into which photographs are incorporated and methods for making the blankets.

### BACKGROUND OF THE INVENTION

Novelty vendors first started applying adhesive-backed decals to t-shirts using heat-based pressing for many years. More recently, manufactures of novelty items such as posters, t-shirts, and mugs began using laminating techniques to apply a decal or image to a substrate by applying a laminate film over the image thereby trapping and fixing the decal or image in between the substrate, such as a t-shirt or mug, and the laminate film. Although these items are often sold as washable, over time, often a very short period of time, the laminate film begins to peel or otherwise deteriorate.

Given the demand of printed novelty items such as mugs and t-shirts having images printed on the items, others have refined the application process including processes that utilize sublimation techniques such as that described in U.S. Pat. No. 4,997,452. However, each type of application typically has unique problems associated with a given substrate or field of use as described in U.S. Pat. No. 4,997,452 that describes a method for applying images onto elastomer-coated Velcro fabrics, U.S. Pat. No. 5,832,819 that describes a method for applying images onto curved surfaces, and U.S. Pat. No. 5,542,351 that describes a method for applying images onto pile fabrics such as velvet, panne and velour that is adapted to overcome problems associated with the high temperatures required for sublimation. As noted in the an article in Sign Business, October 2004, the key to the success of any sublimation process is the discovery of the proper combination of the substrate selected and the specific conditions of the sublimation process used for a given application.

In the past few years, with homemade crafts increasing in popularity and the mainstream availability of digital photo printers, quilters began to apply photographs to fabrics using the lamination techniques to fix the photographs in between the fabrics and the out laminate layer. The laminated-photo fabrics are then stitched together much like a quilt except that these crafts are designed for wall hanging rather than everyday use because of the relative fragility of the outer laminate layer. The crafts cannot be practically used because they cannot withstand the rigors of laundering. These wall hangings are also very labor intensive to make and, as a result, they are usually quite expensive to make and, therefore, to buy. To date, no one has addressed or otherwise solved all these problems or limitations to enable one to make a quilt, blanket, or comforter that can be used for practical, everyday use.

### SUMMARY OF THE INVENTION

It is therefore a primary object of this invention to provide a photograph blanket that can withstand repeated laundering for everyday use.

It is a further object of this invention to provide a method for making a photograph blanket that can withstand repeated laundering for everyday use.

It is a further object of this invention to provide a photograph blanket in which the photos blend seamlessly into the blanket.

The photo blanket of the invention is designed for everyday use and not merely as an aesthetic wall hanging. To do so, the blanket needed to withstand repeated laundering, needed to provide warmth associated with blankets, and needed to be made of materials capable of withstanding the high heat process for applying images to fabrics.

A preferred method of the invention for making the photo blanket of the invention, having a size and shape, generally comprises the steps of: providing one or more digital images; printing a sublimation template for the digital image wherein the template has a size and shape and a front side and backside; providing a deformable printing block corresponding to the size and shape of the sublimation template; providing one or more sublimation substrates, comprising a polyester material and corresponding to the size and shape of the photo blanket; placing the deformable printing block on a surface of a heat press; placing the sublimation substrate on the printing block; placing the sublimation template front side down on the sublimation substrate; and applying the sublimation template to the sublimation substrate by compressing the substrate and template together in the heat press, wherein the sublimation substrate preferably comprises 100% polyester material. The substrate material may be selected from a group consisting of satin, fleece, and micro suede. The heat press is preferably set at about 400 degrees Fahrenheit for about 45 seconds and the deformable printing block is rubber. The method preferably comprises a cooling step after the step of applying.

The method preferably further comprises the steps of, placing a first sheet of tissue paper over the rubber block before the sublimation substrate; and placing a second sheet of tissue paper on top of the backside of the image template prior to the applying step.

The method may also further comprise the step of, marking a location area on the sublimation substrate corresponding to a sublimation template corresponding to a preselected digital image; and wherein the step of placing the sublimation substrate on the printing block comprises placing the location area of the sublimation substrate over the printing block corresponding to the pre-selected sublimation template.

The sublimation substrate may comprise a fleece material that may be preprinted with a design. The preprinted fleece material preferably comprises one or more white areas onto which the sublimation template is applied and into which the image is seamlessly incorporated.

The method may still further comprise a step of fixing the sublimation substrate to a bed comforter, wherein the comforter comprises down.

Another preferred method of making a photo blanket of the invention, having a size and shape, generally comprises the steps of: providing one or more digital images; printing a sublimation template for the digital image wherein the template has a size and shape and a front side and backside; providing a deformable printing block corresponding to the size and shape of the sublimation template; providing one or more sublimation substrates, comprising 100% polyester material and corresponding to the size and shape of the photo blanket; placing the deformable printing block on a surface of a heat press; placing a first sheet of tissue paper on the printing block; placing the sublimation substrate on the tissue paper; placing the sublimation template front side down on the sublimation substrate; placing a second sheet of tissue paper on the backside of the sublimation substrate; and applying the sublimation template to the sublimation substrate by compressing the substrate and template together in the heat press.

The sublimation substrate preferably comprises material selected from a group consisting of satin, fleece, and micro suede. The method may further comprise the step of fixing the sublimation substrate to bed comforter such as a down comforter or a hypoallergenic comforter.

### BRIEF DESCRIPTION OF THE DRAWINGS

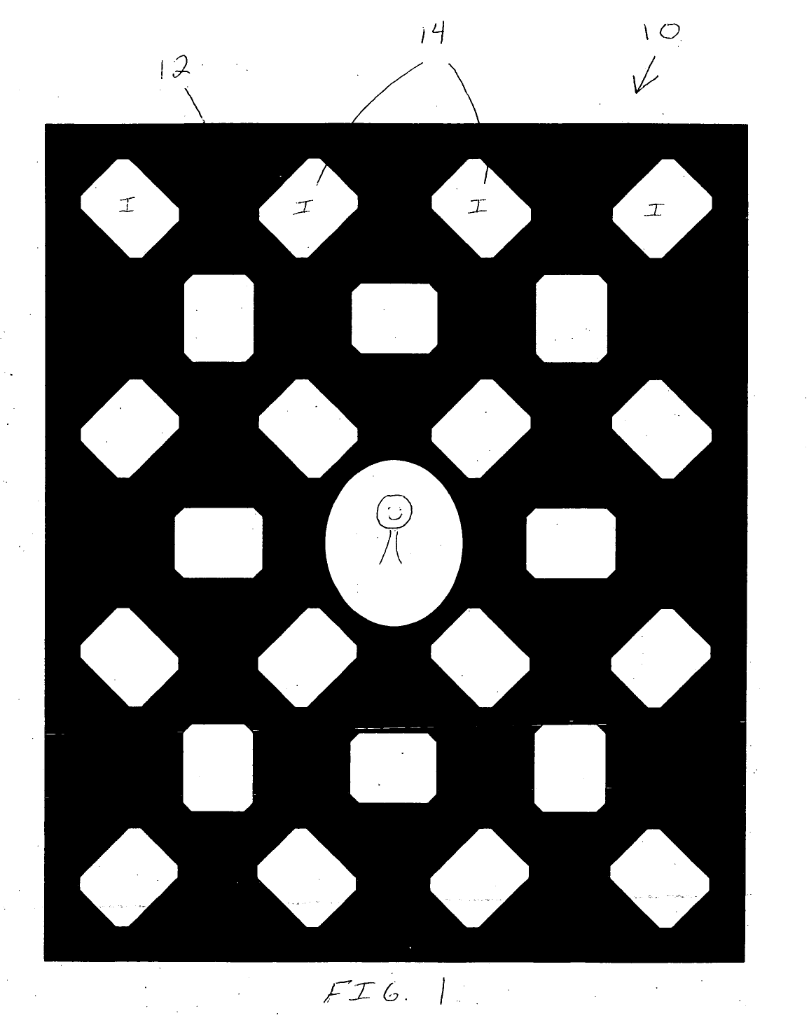

Other objects, features and advantages will occur to those skilled in the art from the following description of the preferred embodiments and the accompanying drawings in which: FIG. 1 is a top view of a preferred embodiment of the blanket of the invention showing the overall layout of images.

### DETAILED DESCRIPTION OF THE PREFERRED EMBODIMENTS AND METHODS

The invention features a photo blanket that can be repeated laundered and is practical for everyday use, and methods for making the photo blanket. The photo blanket provides the further benefit of a blanket into which the images are seamlessly incorporated.

The preferred method of the invention for making a photo blanket begins with the steps of providing, selecting and scanning one or more photographs, or other similar images, into a computer. Once the photographs are scanned into the computer, the photographic images are then enhanced, cropped, and sized as needed or desired to create a template for each image. These steps can be carried out using a software program such as Adobe Photoshop. The templates for each of the photographs are then printed using inks and paper suitable for sublimation.

Using the templates as a guide, rubber blocks are cut to the shape and size of each image to be transferred. Similarly, using the templates as a guide, the selected blanket sublimation substrate, onto which the images will be transferred, is marked to plan to overall layout of the images on the blanket. An example of such an overall layout is shown in FIG. 1, which refers to blanket 10 which generally comprising substrate 12 and a plurality of images 14. The number of images, layout, shapes, sizes, and colors used in the photo blanket are only limited by the imagination of the blanket designer.

The rubber blocks are then placed on a heat press, preferably set at 400 degrees Fahrenheit, and having a table surface. A sheet of tissue paper is placed over the rubber block to protect the sublimation fabric substrate. The portion of the marked sublimation substrate corresponding to a given image is laid on top of the tissue paper. Then the template for the corresponding image is placed face down onto the sublimation substrate. Another sheet of tissue paper is placed on top of the backside of the image template. Then the cover of the heat press is closed over the top layer of tissue paper and allowed to set for about 45 seconds. During the heating process, the high temperature opens the fibers of the fabric, allowing the inks to penetrate into the fabric. When the cover is open, the fabric is cooled to seal in the ink. Each image is preferably applied individually. However, for purposes of commercial production, a larger press or automated system can be used to apply the images more quickly and efficiently, particularly when used in combination with a programmable computer and hopper system for automatically feeding and placing the images according to a predetermined program.

The preferred blanket substrate is preferably 100% polyester and may be selected from a group consisting of satins, fleece, and micro suede. These materials may still further be applied to a more substantial blanket material including down comforters and down-alternative comforters such as hypoallergenic comforter materials. In instances in which the sublimation substrate comprises a fleece material, the material may be preprinted with a design. The preprinted fleece material preferably comprises one or more white areas onto which the sublimation template is applied and into which the image is seamlessly incorporated. For example, the fleece material may have one or more scenes, designs, or writing printed or dyed into the material. In one embodiment, the scene comprises a plurality of white clouds. These white clouds provide an optimal area on the fleece material or sublimation substrate onto which the sublimation template is place and into which the images are seamlessly incorporated. In such an embodiment, it appears as though the images are framed within the clouds in the sky. Such preprinted or predyed materials can be modified to include an unlimited type of background images and/or frames into which the photographic images may be seamlessly incorporated. The photographic images and sublimation templates can be shaped, cut, and/or sized to fit perfectly within a predetermined area on the sublimation substrate. The blankets of the invention are ideal for babies because they are seamless and smooth to touch.

The imprinted substrate is then cut, preferably to just under the size of the blanket to provide a border around the imprinted substrate. The boarder is then sewn to the pre-cut substrate, which, as a unit, is then sewn or otherwise applied to a more substantial blanket material such as a down comforter, hemming in all of the sides. All the layers of the blanket or comforter are then preferably tacked together in a plurality of evenly distributed locations, preferably about 20 for a standard-sized blanket, to hold all the layers in place.

Although specific features of the invention are shown in some drawings and not others, this is for convenience only as some feature may be combined with any or all of the other features in accordance with the invention.

Other embodiments will occur to those skilled in the art and are within the following claims:

What is claimed is:

1. A method of making a photo blanket having a size and shape comprising the steps of:
providing one or more digital images;
printing a sublimation template for said digital image wherein said template has a size and shape and a front side and backside;
providing a deformable printing block corresponding to the size and shape of said sublimation template;
providing one or more sublimation substrates, comprising a polyester material and corresponding to said size and shape of said photo blanket;
placing said deformable printing block on a surface of a heat press;
placing said sublimation substrate on said printing block;
placing said sublimation template front side down on said sublimation substrate; and
applying said sublimation template to said sublimation substrate by compressing said substrate and template together in said heat press.

2. The method of claim 1 wherein said sublimation substrate comprises 100% polyester material.

3. The method of claim 2, wherein said 100% polyester material is selected from a group consisting of satin, fleece, and micro suede.

4. The method of claim 1, wherein said heat press is set at about 400 degrees Fahrenheit.

5. The method of claim 1, wherein said deformable printing block is rubber.

6. The method of claim 1, further comprising the steps of,
placing a first sheet of tissue paper over the rubber block before the sublimation substrate; and
placing a second sheet of tissue paper on top of said backside of the image template prior to said applying step.

7. The method of claim 1, further comprising the step of, marking a location area on said sublimation substrate corresponding to a sublimation template corresponding to a preselected digital image; and wherein said step of placing said sublimation substrate on said printing block comprises placing said location area of said sublimation substrate over said printing block corresponding to said preselected sublimation template.

8. The method of claim 1, wherein said step of applying comprises applying heat at about 400 degrees Fahrenheit for about 45 seconds.

9. The method of claim 1, further comprising the step of cooling said sublimation substrate after said applying step.

10. The method of claim 1, further comprising the step of fixing said sublimation substrate to a bed comforter.

11. The method of claim 10, wherein said comforter comprises down.

12. The method of claim 1, wherein said step of applying comprises incorporating said sublimation template into the sublimation substrate so that said image is seamlessly incorporated into the sublimation substrate.

13. A photo blanket made using the method of claim 11.

14. A photo blanket made using the method of claim 1.

15. A method of making a photo blanket having a size and shape comprising the steps of:
providing one or more digital images;
printing a sublimation template for said digital image wherein said template has a size and shape and a front side and backside;
providing a deformable printing block corresponding to the size and shape of said sublimation template;
providing one or more sublimation substrates, comprising 100% polyester material and corresponding to said size and shape of said photo blanket;
placing said deformable printing block on a surface of a heat press;
placing a first sheet of tissue paper on said printing block;
placing said sublimation substrate on said tissue paper;
placing said sublimation template front side down on said sublimation substrate;
placing a second sheet of tissue paper on said backside of said sublimation substrate; and
applying said sublimation template to said sublimation substrate by compressing said substrate and template together in said heat press.

16. The method of claim 15, wherein said sublimation substrate comprises material selected from a group consisting of satin, fleece, and micro suede.

17. The method of claim 15, further comprising the step of fixing said sublimation substrate to bed comforter.

18. The method of claim 17, wherein said bed comforter comprises down.

19. The method of claim 17, wherein said comforter is hypoallergenic.

20. A photo blanket made using the method of claim 15.
